(19) United States
(12) Patent Application Publication
(10) Pub. No.: US 2008/0286319 A9
(43) Pub. Date: Nov. 20, 2008

(54) Antimicrobial surfaces and methods for preparing antimicrobial surfaces

(76) Inventors: Alan J. Russell, Wexford, PA (US); Richard Koepsel, Pittsburgh, PA (US); Sang Boem Lee, Pittsburgh, PA (US); Krzysztof Matyjaszewski, Pittsburgh, PA (US)

Correspondence Address: JESSE A. HIRSHMAN, ESQ., 1722 MURRAY AVENUE, THIRD FLOOR, PITTSBURGH, PA, 15217, US

(21) Appl. No.: 10/887,029

(22) Filed: Jul. 7, 2004

Related U.S. Application Data
(60) Provisional application No. 60/485,957, filed on Jul. 10, 2003.

(51) Int. Cl. A01N 25/34

(52) U.S. Cl. 424/402

(57) ABSTRACT

The present invention relates to biocidal articles. In an embodiment the biocidal article comprises a plurality of polymers having biocidally active groups. The polymers are attached to a surface and may have a polydispersity less than 3. The biocidally active groups may comprise at least one of a quaternary ammonium salt, a quaternary phosphonium salt or a chloroamine. The attached polymers may be any microstructure, topology or composition, such as, a homopolymer, block copolymer, multiblock copolymer, a random copolymer, graft polymer, a branched or a hyperbranched polymer, and a gradient copolymer. The present invention also comprises a process for the preparation of a biocidal article. Embodiments of the process comprise polymerizing radically polymerizable monomers from an initiator attached to a surface, wherein at least a portion of the monomers comprise a group capable of being converted to a biocidally active group, and converting the group to the biocidally active group.

### CROSS REFERENCE TO RELATED APPLICATIONS

This application is a nonprovisional application claiming priority from U.S. Application Ser. No. 60/458,957 filed on Jul. 10, 2003.

### TECHNICAL FIELD

Biocidal surfaces and methods for preparing biocidal surfaces are provided. Embodiments of the invention comprise surfaces having attached polymers with pendant quaternary ammonium salts. The modified surface inhibits the growth of microorganisms, such as, bacteria, including Gram positive and Gram negative bacteria, fungi, mildew, mold, and algae.

### BACKGROUND

The control of microorganisms such as bacteria, fungi, mold, mildew, and algae in humid environments or on moist surfaces has long been a matter of concern. The mechanism by which an antimicrobial acts determines how it can be used in surface treatments. Most conventional antimicrobials act by diffusing into the cell and disrupting essential cell functions. In order to use this type of compound for surface treatment, the antimicrobial must be released from the surface matrix. These leaching antmicrobial surfaces typically contain antibiotics, phenols, iodine, quaternary ammonium compounds, or heavy metals such as silver, fin and mercury. The fact that the antimicrobial is free to leave the surface has serious adverse effects on the durability and useful life of the treated material. Another potentially serious problem with leaching technologies is that if the compounds are released into the environment at sub-lethal concentrations, thereby having the potential effect of increasing antimicrobial resistance throughout the microbial realm. Recently. renewable halide leaching antimicrobial surface coatings for fabrics and other surfaces have been disclosed. The antimicrobial activity may be renewed by treating the surface with bleach. Renewable leaching antimicrobial surfaces are effective at killing bacteria, but suffer from the limitation that they need to be regenerated in order to maintain activity.

The more unconventional route to the production of surface-active antimicrobial materials is to bind an antimicrobial to a surface through covalent interactions. Various attempts of this type have been made to address the deficiencies inherent in leaching type antimicrobial surfaces. Although these strategies have been effective in isolated aqueous solutions containing microorganisms, many of these compounds also are toxic to higher forms of life.

Attempts have been made to chemically bond an active antimicrobial substance to various surfaces by various techniques, such as antimicrobial substances formed by classical, uncontrolled free radical polymerization. Tiller, et al., have disclosed the treatment of a number of flat surfaces, such as glass, high-density polyethylene (HDPE), low-density polyethylene (LDPE), polyprolylene (PP), Nylon, and poly(ethylene terephthalate), with poly(4-vinyl-pyridine) having pendant quaternary ammonium salts. [Proceedings of the National Academy of Sciences of the United States of America, vol. 98, 5981 (2001) and Biotechnology and Bioengineering, vol. 79, 465 (2002)]. The antibacterial property of this type of material was assessed by spraying aqueous suspensions of bacteria cells on the surfaces. While the surfaces did have some antimicrobial activity, the level of activity was unremarkable.

The ability of these surfaces having attached polymers that were preformed by classical uncontrolled free radically-prepared polymers to kill applied organisms was not equal to the leaching types of antimicrobial surface preparations. Interestingly, when the applied polymer was a poly-quaternary amine, it was able to kill bacteria that were resistant to other types of cationic antimicrobials. The active material for all of the above biocidal surfaces was synthesized by either classical uncontrolled free radical polymerization or by simple coupling reactions and then subsequently bonded to an activated surface. Classical uncontrolled free radical polymerization reactions fail to strictly control the monomer distribution, polydispersity, molecular weight, polymer topology, and density of functional groups in a way that will allow rational modification of the polymer.

Additionally, a glass surface modified with a polyethylenimine having quaternary ammonium salt groups has been disclosed by Lin, et al., Biotechnology Progress, vol. 18, 1082 (2002). The antimicrobial activity disclosed is similar to those of Tiller et al.

Much higher levels of antimicrobial activity must be achieved before these surfaces can be useful for various medical and personal care surfaces such as door knobs, children's toys, computer keyboards, and telephones to render them antiseptic and thus unable to transmit bacterial infections.

Other types of bioactive surface treatments have been reported. Biocidal polyurethane surfaces having pendant quaternary ammonium groups prepared by using conventional polycondensation polymers are disclosed by Sengupta et al., PCT Pat. No. WO 02/10244 A2. Polymerizable compositions having acrylate monomers with pendant quaternary ammonium groups are disclosed by Imazato et al., U.S. Pat. No. 5,408,022 and 5,494,987. The Imazato compositions provide an non-releasable antimicrobial polymer useful for applying to the surface of medical articles, in general, and as a restorative material for dental caries, in particular. A polyurethane having an acrylate group at each of its molecular ends is used as a bifunctional crosslinking agent for the acrylate polymers and allows properties such as, hardness, strength and thermal resistance of the antimicrobial polymer to be varied according to the requirements of the intended use. These materials are completely end-capped. Based on the disclosed chemistry, these compositions do not form an aqueous dispersion and when applied as a coating are cured or polymerized on the surface.

Wang and Lin, Journal of Polymer Research, vol. 5,177 (1998), reported antimicrobial fabric finishes made from polyurethanes to which quaternary ammonium siloxanes had been attached through epichlorohydrin grafted to the polymer chain. Wang and Lin use dimethylformamide to form solutions for applying their polyurethanes to a substrate surface. In the above examples, rather complex and relatively expensive chemistries are used to attach quaternary ammonium groups to a polyurethane polymers. According to the methods disclosed therein all of those biocidal surfaces were made by either classical, uncontrolled free radical polymerization or simple coupling reactions. Thus, when the polymer is prepared by conventional uncontrolled polymerization methods, the ability to produce antimicrobial properties by designed structural changes of polymer composition on surfaces is limited because the control of monomer sequence distribution, functionality, molecular weight, polydispersities and polymer topology is not possible.

Another way to generate biocidal surfaces is to produce an interpenetrating polymerized network of the antimicrobial material. This type of process works well with porous or fibrous materials but not with solid surfaces. Interpenetrating networks are disclosed in U.S. Pat. No. 6,146,688. In that reference, to generate the interpenetrating network (IPN), aminopropyltriethoxysilane (3-APTS) is subjected to a quaternization reaction, sprayed onto the surface of a cloth material and then polymerized in situ. This process is currently commercialized as Microbe Shield® by Aegis Environments. The disadvantages to this process include the extensive use of organic solvents for the preparation of the polymer and the fact that the size and exact composition of the polymer are difficult to control. Finally, as stated above the IPN type reaction will only work with materials that are highly porous or are fibrous.

### SUMMARY

The present invention relates to biocidal articles. In an embodiment the biocidal article comprises a plurality of polymers having biocidally active groups. The polymers are attached to a surface and may have a polydispersity less than 3. The biocidally active groups may comprise at least one of a quaternary ammonium salt, a quaternary phosphonium salt or a chloroamine. The attached polymers may be any microstructure, topology or composition, such as, a homopolymer, block copolymer, multiblock copolymer, a random copolymer, graft polymer, a branched or a hyperbranched polymer, and a gradient copolymer.

The present invention also comprises a process for the preparation of a biocidal article. Embodiments of the process comprise polymerizing radically polymerizable monomers from an initiator attached to a surface, wherein at least a portion of the monomers comprise a group capable of being converted to a biocidally active group, and converting the group to the biocidally active group.

### BRIEF DESCRIPITION OF THE FIGURES

FIGS. 1A and 1B shows the Live/Dead analysis of E. coli incubated with paper cells incubated with non-modified paper for 15 minutes (FIG. 1A) and cells incubated with modified paper for 15 minutes (FIG. 1B); and

FIGS. 2A, 2B, and 2C are atomic force microscopy (“AFM”) images of E. coli. cells on glass surfaces showing E. coli. cells on plain glass (FIG. 2A); E. coli. cells on quaternized glass (FIG. 2B); quaternized glass without cells (FIG. 2C).

### DESCRIPTION OF EMBODIMENTS OF THE INVENTION

Embodiments of the present invention include biocidal articles. A biocidal article of the present invention may comprise a plurality of polymers having biocidally active groups attached to a surface of the article. The polymers may have a molecular weight distribution less than 3, less than 2.5, in certain applications, it may be preferable to have a molecular weight distribution of less than 2.0. Polydispersity index (“polydispersity”) is a measure of the molecular-weight nonhomogeneity in a polymer system; that is, there is some molecular-weight distribution throughout the polymer body. Polydispersity is defined as the ratio of the number average degree of polymerization and the weight average degree of polymerization. The degree of polymerization if defined as the number of monomer units in an average polymer molecule in a given sample. Controlled polymerization process may be conducted in such a manner to result in polymers having these properties by methods known in the art, such as the methods taught in the references cited below.

The biocidally active groups may be any functionality or any group that may inhibit the growth, inhibit the reproduction, or kill spores or microorganisms, such as a quaternary ammonium salt, a quaternary phosphonium salt or a chloroamine. Certain embodiments may comprise biocidally active groups with cationic antimicrobial activity. Though not meant to limit the scope of the inventor, such biocidally active groups may function by disrupting the cell membrane of the microorganism.

The plurality of polymers attached to the surface may be of any monomer distribution, molecular weight, topology, and may comprise additional monomers that do not comprise biocidally active groups. Therefore, embodiments of the biocidal articles of the present invention may include any radically polymerizable monomer. The additional monomers may be chosen to add properties to the attached polymer, such as hydrophobicity, hydrophilicity, hardness, resistance to solvents, elastomeric properties, elevation or reduction of the glass transition temperature, resistance to corrosion or wear, or other properties that may functionality of the biocidal article. In addition, the attached polymer may be one of a homopolymer, block copolymer, multiblock copolymer, a random copolymer, graft polymer, a branched or a hyperbranched polymer, and a gradient copolymer, such as a graft copolymer having a hydrophobic backbone and pendant hydrophilic functional groups, such that at least a portion of the plurality of polymers comprise at least one monomer selected from hydrophilic monomers and hydrophobic monomers. The polymer structure may be designed to enhance the bioactivity of the surface for specific applications of embodiments of the present invention.

The plurality of polymers may also be designed according to known practices in the art of controlled polymerization, such that the polymers may comprise three or more different monomer units, if desired, and have an average degree of polymerization between 4 and 5000, between 4 and 1000, or in certain applications, it may be preferable to have an average degree of polymerization between 100 and 1000.

The control of polymer compositions, architectures, and functionalities for the development of materials with biological properties has long been of great interest in polymer chemistry. Atom Transfer Radical Polymerization (ATRP), nitroxide mediated polymerization (NMP), reversible addition fragmentation chain transfer (RAFT) and catalytic chain transfer (CCT) are examples of controlled/living radical polymerization processes (CRP) that provides a relatively new and versatile method for the synthesis of polymers with controlled molecular weights and low polydispersities. Indeed, since CRP processes provide compositionally homogeneous well-defined polymers (with predicted molecular weight, narrow molecular weight distribution, and high degree of end-functionalization) they have been the subject of much study as reported in several review articles. [Matyjaszewski, K., Ed. Controlled Radical Polymerization; ACS: Washington, D. C., 1998; ACS Symposium Series 685. Matyjaszewski, K., Ed. Controlled/Living Radical Polymerization. Progress in ATRP, NMP, and RAFT; ACS: Washington, D. C., 2000; ACS Symposium Series 768. Matyjaszewski, K., Davis, T. P., Eds. Handbook of Radical Polymerization; Wiley: Hoboken, 2002. Qiu, J.; Charleux, B.; Matyjaszewski, K. Prog. Polym. Sci. 2001, 26, 2083. Davis, K. A.; Matyjaszewski, K. Adv. Polym. Sci. 2002, 159, 1.]

ATRP is presently one of the most robust CRP and a large number of monomers can be polymerized providing compositionally homogeneous well-defined polymers having predictable molecular weights, narrow polydispersity, and high degree of end-functionalization. Matyjaszewski and coworkers have produced a number of patents and patent applications related to ATRP (U.S. Pat. Nos. 5,763,546; 5,807,937; 5,789,487; 5,945,491; 6,111,022; 6,121,371; 6,124,411; 6,162,882; 6,407,187; 6,512,060; and U.S. patent applicatons Ser. Nos. 09/018,554; 09/359,359; 09/359,591; 09/369,157; 09/534,827; 09/972,046; 09/972,056; 09/972,260; 10/034,908; and 10/098,052) all of which are herein incorporated by reference.

In describing aspects of the invention certain terms used are defined below:

“ATRP” refers to a living radical polymerization described by Matyjaszewski in the Journal of Americal Chemical Society, vol. 117, page 5614 (1995), as well as in ACS Symposium Serves 768, and Handbook of Radical Polymerization, Wiley: Hobolcer 2002, Matyiaszewski, K and Davis, T, editors, all hereby incorporated by reference.

“ATRP initiator” is a chemical molecule, with a transferable (pseudo)halogen that can initiate chain growth. Fast initiation is important to obtain well-defined polymers with low polydispersities. A variety of initiators, typically alkyl halides, have been used successfully in ATRP. Many different types of halogenated compounds are potential initiators.

“Biocidal,” “biocidally active” and “antimicrobial” refer to a compound or to the ability of any composition or group to inhibit the growth of, inhibit the reproduction of or kill microorganisms: such as, without limitation, spores and bacteria, fungi, mildew, mold, and algae.

“Surface” as used herein means a surface having functionality that may be inherent to the surface or the surface can be converted to have attached functionality. The functionalities are groups that can be employed to attach a polymer chain to the surface by a grafting from polymerization process. These functionalities are chemical moieties, such as nitroxides, pseudo halogens, unsaturated groups, halides, hydroxyl groups, or amino groups. Examples of surfaces include, without limitation, plain glass, amino glass, steel, papers, wood, wool, cotton surfaces comprising cellulosic materials, porous glass beads, and ion exchanger resins. Many other surfaces are possible.

The present invention provides biocidal materials, such as surfaces, that include polymers having biocidially active groups, such as, quaternary ammonium salts and phosphonium salts. The preparation of such materials is exemplified by the growth of the polymers from a surface having an CRP initiator, such as an ATRP initiator. However this does not exclude the use of other functional groups which could be used to initiate different CRP processes such as nitroxide mediated polymerizations. Living/controlled polymerizations (exemplary controlled polymerizations are polymerizations where chain breaking reactions such as transfer and termination may be minimized if desired) enable control of various parameters of macromolecular structure, such as molecular weight, polydispersity and terminal functionalities. Living/controlled radical polymerizations, typically, but not necessarily, comprise a low stationary concentration of radicals, in equilibrium with various dormant species.

In the context of the present invention, the term “controlled” refers to the ability to produce a product having one or more properties which are reasonably close to their predicted value (presuming a particular initiator efficiency). For example, if one assumes 100% initiator efficiency, the molar ratio of monomer to initiator leads to a particular predicted molecular weight.

Similarly, one can “control” the polydispersity by ensuring that the rate of deactivation is the same or greater than the initial rate of propagation. However, the importance of the relative deactivation/propagation rates decreases proportionally with increasing polymer chain length and/or increasing predicted molecular weight or degree of polymerization. Controlled radical polymerizations may produce polymers that, when grown from surfaces, have narrow molecular weight distributions, or polydispersities, such as less than or equal to 3, or in certain embodiments less than or equal to 2.0 or less than or equal to 1.5. In certain embodiments, polydispersities of less than 1.2 may be achieved.

Embodiments of the present invention also include a process for preparing a biocidally active surface. The process may include reacting monomers with a surface by a controlled radical polymerization to form a polymer attached to the surface, wherein at least a portion of the monomers comprise a biocidally active group. Further embodiments of the process include a process for preparing a biocidally active surface including reacting monomers with a surface by a controlled radical polymerization to form a polymer attached to the surface, wherein at least a portion of the monomers are capable of being converted to a biocidally active group. In such a case that the monomers may be reacted with an activating compound to provide the biocidally active group.

Many monomers have been successfully polymerized by CRP, see Handbook of Radical Polymerization. The polymers attached to the surface may be homopolymers, copolymers, block polymer, graft polymers, dendritic polymers, random copolymers, comb polymers, branched polymers, star polymers, polymeric brushes, as well as any other polymeric structure that allow access of the biocidically active groups to the organism. The biocidially active group may be incorporated into the entire backbone, a single block, multiple blocks, or branches of the homopolymers or copolymer or in more than one part of the polymer.

Embodiments of the invention also comprise chain extending or grafting from the attached polymer before or after forming the biocidially active group. The subsequent polymerization does not need to be controlled, however, certain applications may benefit from the use of a controlled polymerization. Additionally, further non-polymerization reactions may be performed on the attached polymer, such as, for example, cross-linking, reactions to modify the phylicity of the surface, adding reactive sites, as well as other purposes.

The polymers attached to the surface may comprise biocidally active groups attached to the terminus after polymerization by known chemical modification techniques or the biocidally active groups may be part or subsequently attached to the monomers making up the polymer. In the case in which the biocidally active groups are part of or attached to the monomers, the attached polymers may be homopolymers of such monomers or copolymers of such monomers such that less than 75% of all the monomers in the plurality of polymers are biocidally active, less than 50% of all the monomers in the plurality of polymers are biocidally active, less than 25% of all the monomers in the plurality of polymers, or in certain embodiments it may be preferable that less than 5% of all the monomers in the plurality of polymers are biocidally active. The modified surfaces may comprise polymers having quaternary amines produced from any unsaturated, radically polymerizable, monomer containing a primary, secondary or tertiary nitrogen (or a functionality that can be converted into quaternary amine after the polymerization reaction). Monomers comprising the biocidally active groups may be derived from monomers such as 2-(dimethylamino)ethyl methacrylate (DMAEMA), 4-vinyl pyridine, 2-vinyl pyridine, N-substituted acrylamides, N-acryloyl pyrrolidine, N-acryloyl piperidine, acryl-L-amino acid amides, acrylonitriles, methacrylonitriles vinyl acetates, 2-hydroxy ethyl methacrylate, p-chloromethyl styrene, and derivatives and substituted varieties of such monomers. Polymers comprising these monomeric compounds can easily be converted to chemical forms with known anitmicrobial activity including the facile conversion of DMAEMA to a corresponding series of quaternary amines. For example, ATRP can be used as a robust mechanism for growing long chain, low polydispersity polymers on Whatman #1 filter paper and on amino glass slides using DMAEMA as a monomer. The tertiary amino group of the DMAEMA, which is pendant to the main chain of the polymer, is easily quarternized by different chain lengths of alkyl halides to provide an effective biocidal functionality.

The amino groups on such monomers may be converted to a quaternary salt comprises reacting the group with an alkyl halide. In embodiments, the alkyl halide may be any one of C₁-C₂₀ alkyl halide. Such as, but not limited to, methyl chloride, methyl iodide, methyl bromide, ethyl bromide, butyl bromide, pentyl bromide, hexyl bromide, heptyl bromide, octyl bromide, nonyl bromide, decyl bromide, undecyl bromide, dodecyl bromide, tridecyl bromide, tetradecyl bromide, heptadecyl bromide, or hexadecyl bromide. The halide of the alkyl halide may be either one of chlorine, bromine, fluorine, and iodine.

Surprisingly, the present invention provides a process for successful synthesis of well-defined biocidal surfaces having a high density of quaternary ammonium salts, and higher biocidal activity than other preparations. Such biocidal surfaces can only be prepared by avoiding chain terminations from chain transfer, radical coupling, or disproportionation during the polymerization reaction. These deleterious side reactions are best controlled by conducting a CRP reaction with monomers capable of being converted to biocidially active groups, herein exemplified by ATRP.

For example, the following modified monomeric units may add biocidal activity to a polymer:

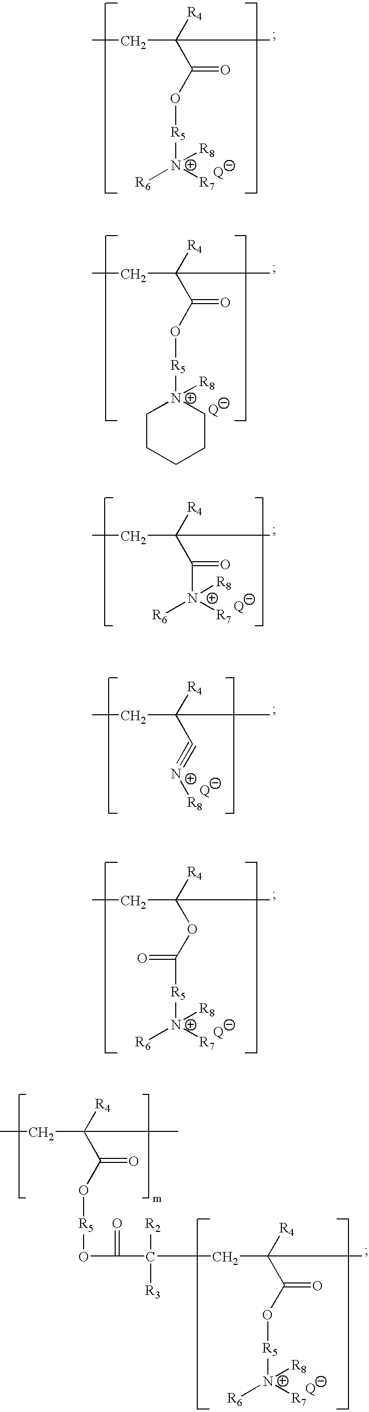

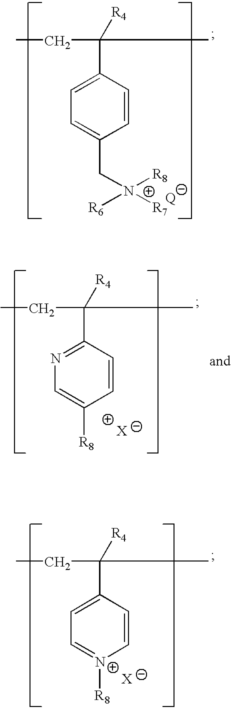

where R₄ is one of H, CH₃, Cl or CN, R₅ is —(CH₂)ₙ— and —CH₂C(CH₃)₂CH₂—, n is from 1 to 6, R₆ and R₇ are, independently, one of alkyl C₁-C₅ or isopropyl, R₈ is H, alkyl C₁-C₁₆ and benzyl and Q is one of F, Cl, Br, I, CF₃SO₃ and CF₃CO₂, individually or in any combination each, X is a radically transferable atom or group or a group derived from the radically transferable atom or group, such as an additional polymer block, a hydroxy group, H, branched or straight chain alkyl or cyclic, and Q is one of F, Cl, Br, I, CF₃SO₃ and CF₃CO₂.

In preferred embodiments, a process of the present invention comprises polymerizing the radically polymerizable monomers by a controlled polymerization process, such as one of atom transfer radical polymerization and stable free radical polymerization. For an atom transfer radical polymerization, the polymerizing may be in the presence of a system initially comprising a transition metal complex and initiator attached to the surface comprises a radically transferable atom or group as described in the prior art, such as the references concerning atom transfer radical polymerization that were previously cited. The radically transferable atom or group may be one of a halogen, a pseudohalogen, chlorine, iodine, and bromine.

Embodiments of the process of present invention may further comprise reacting a compound comprising an initiation group with a functional group on the surface of the article to form the initiator attached to the surface. Typical surface functional groups include hydroxy and amino groups, though other groups capable of conversion to initiation sites may also be used. If only a portion of the surface functional groups are desired to have attached polymers, a blocking agent without initiation functionality may be reacted with the functional group on the surface of the article. This will prevent forming an initiation site on such a surface functional group. This is one way to modify the density of the grafted polymers on a macroscale or microscale. The initiation sites may be patterned only on specific areas of the article if desired. Any ratio of blocking agent to compound with initiation functionality may be used. If a high degree of polymer density is desired for an application the ratio may be greater than 1:3, for example. For lower attached polymer density the ratio of blocking agent without initiation functionality to compound with initiation functionality is greater than 1:1, greater than 10:1 or even greater or less than 100:1.

The plurality of polymers may be attached to any surface that has or may be modified to have controlled polymerization initiation sites. Suitable surface may be comprised of silicon, gold, silica functionality, a cellulosic material, a material at least one of amino and hydroxy functionality, plain glass, amino glass, polymeric material, a polymeric coating, polyethylene, polypropylene, polystyrene, aluminum, steel, paper, wood, porcelain, wool, cotton, porous glass beads and ion exchanger resin. A linking group between such surfaces and the attached polymer may be formed. Any linking group may be used, such as a linking group is of the formula:

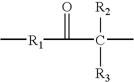

where R₁ is one of O, an ester, amide, aliphatic hydrocarbon, aromatic hydrocarbon or NH, R₂ and R₃ are, independently, one of H, CH₃, OOCC₂H₅ or CN.

Embodiments of the present invention also include a process for the preparation of a biocidal article. Such an embodiment may include polymerizing radically polymerizable monomers from an initiator attached to a surface, wherein at least a portion of the monomers comprise at least one biocidally active group or a group capable of being converted to a biocidally active group. If the monomer comprises a monomer having a group capable of being converted to the biocidally active group, an embodiment of the process may also include converting the group to the biocidally active group.

Scheme 1 outlines an embodiment of the synthetic pathway for the ATRP polymerzation and subsequent quaternization of DMAEMA on solid surfaces. 2-bromoisobutyryl bromide was reacted with the hydroxyl groups of the cellulose in filter paper and the free amine groups on amino glass slides via esterification to produce the active ATRP initiator on surface. ATRP was then used to polymerize DMAEMA to the initiated surfaces. Cu(I)Br and the ligand bipyridine served as catalysts in the ATRP reaction, and 1,2-dichlorobenzene was used as the solvent. After washing, the materials were quaternized with an alkyl halide using nitromethane as a solvent.

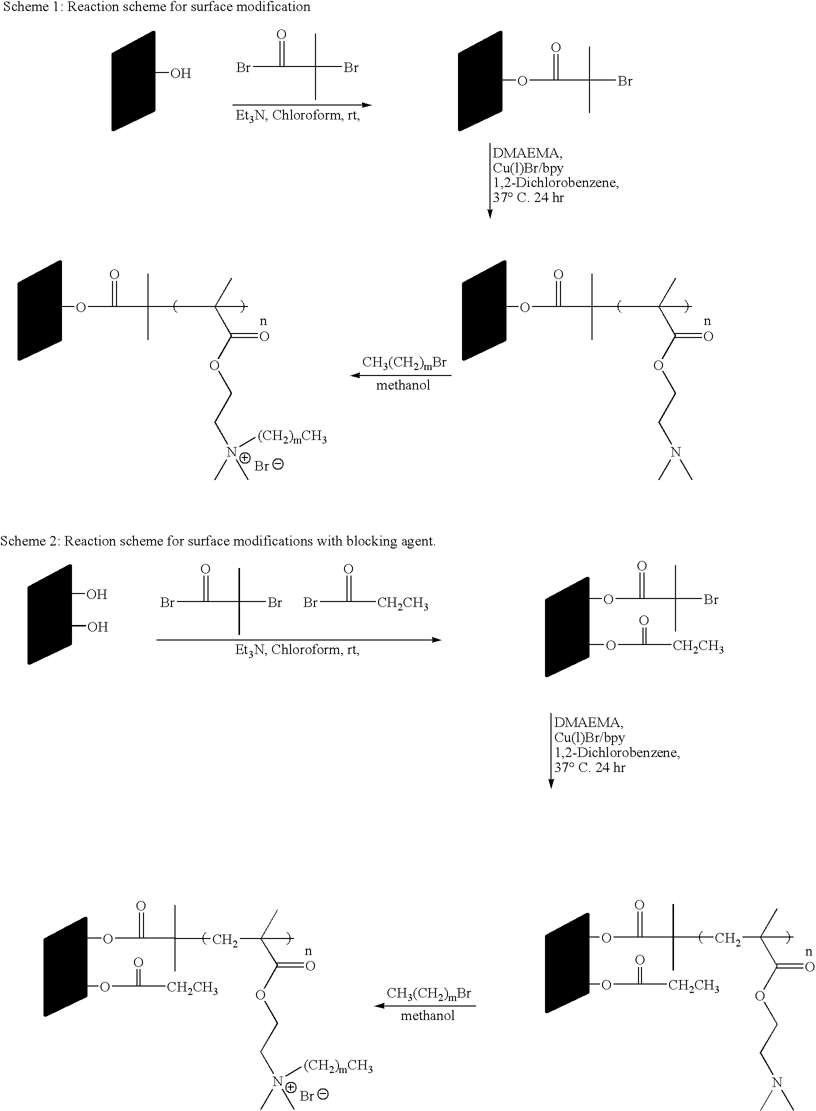

In some experiments, a “blocking agent” was used to synthesize filter papers with varying surfaces densities of the biocidal polymer as shown in Scheme 2. Propionyl bromide was mixed with stoichiometrically varying amounts of 2-bromoisobutyryl bromide to vary the density of active ATRP initiation sites on the paper. The propionyl bromide reacts with the hydroxyl groups found on the filter paper to produce a non-polymerizable site. To determine the molecular weight of the polymers synthesized by this method, papers were prepared with different initiator densities and the completed polymer chains were cleaved from the surface by HCl hydrolysis. The molecular weights and polydispersities of the cleaved polymers were determined using gel permeation chromatography. The GPC data for these experiments presented in Table 1 show that the extent of the polymerization reaction and thus the length of the polymer and the polydispersity are not greatly influenced by the number of initiation sites. This method may be used to vary the percentage converison of potential sites to initiation sites from 0-100%. In some embodiments, a conversion of between 30-70% may be desired.

TABLE 1
Results from GPC after Hydrolysis

| Percent of initiator on surface | Mₙ/g mol⁻¹ | PDI |
|---|---|---|
| 100 | 21,000 | 2.22 |
| 50 | 23,000 | 2.21 |
| 10 | 19,000 | 2.14 |

### EXAMPLES

### Example 1

### Immobilization of ATRP Initiator on Whatman 1 Filter Paper

A paper with immobilized ATRP initiator was prepared by reacting 5 ml of 2-bromoisobutyryl bromide with the hydroxyl groups present on the filter paper (25 mm×25 mm) for 24 h at room temperature. The filter paper was thereafter thoroughly washed with dichloromethane/acetone/water.

The number of initiator sites on a given paper sample can be controlled by reacting the hydroxyl groups present on the filter paper with a mixture of 2-bromoisobutyryl bromide and an increasing amount of propionyl bromide, the propionyl bromide acts as blocking agent since it does not include a functionality for ATRP initiation. In this manner one can obtain paper samples with 0% to 100% ATRP initiator functionalities immobilized on the paper.

### Example 2

### ATRP of DMAEMA from Paper with 100% of ATRP Initiator Sites and its Quaternization by ethyl bromide

ATRP of DMAEMA from the paper surface was accomplished by immersing the “100%” initiator-modified paper, prepared in accordance with Example 1, into a reaction mixture containing 5 g of DMAEMA, 0.035 g of CuBr, 0.070 g of 2,2′-bipyridine (bpy), and 5 g of 1,2-dichlorobenzene. The polymerization was carried out at 80° C. for 48 h. After completion of the polymerization the paper was subjected to intense washing: first with THF, then THF: water, and finally water, air dried, before being placed in a solution of 5 ml of ethyl bromide in 15 ml of nitromethane. After stirring the reaction mixture at 30° C. for 24 h, the paper was rinsed with THF, methanol, water, and dried under vacuum for 24 h.

### Example 3

### ATRP of DMAEMA from Paper with 75% of ATRP Initiator and its Quaternization by ethyl bromide

ATRP of DMAEMA on paper was accomplished by immersing the 75% initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of ethyl bromide in 15 ml of nitromethane was used for quaternization. The polymerization and quaternization were conducted in accordance with Example 2.

### Example 4

### ATRP of DMAEMA from Paper with 50% of ATRP Initiator and its Quaternization by ethyl bromide

ATRP of DMAEMA on paper was accomplished by immersing the 50% initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of ethyl bromide in 15 ml of nitromethane was used for quaternization. The polymerization and quaternization were conducted in accordance with Example 2.

### Example 5

### ATRP of DMAEMA from Paper with 25% of ATRP Initiator and its Quaternization by ethyl bromide

ATRP of DMAEMA on paper was accomplished by immersing the 25% initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of ethyl bromide in 15 ml of nitromethane was used for quaternization. The polymerization and quaternization were conducted in accordance with Example 2.

### Example 6

### ATRP of DMAEMA from Paper with 1% of ATRP Initiator and its Quaternization by ethyl bromide

ATRP of DMAEMA on paper was accomplished by immersing the 1% initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of ethyl bromide in 15 ml of nitromethane was used for quaternization. The polymerization and quaternization were conducted in accordance with Example 2.

### Example 7

### ATRP of DMAEMA from Paper with 100% of ATRP Initiator and its Quaternization by methyl chloride

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of methyl chloride in 15 ml of nitromethane was used for quaternization. The polymerization and quaternization were conducted in accordance with Example 2.

### Example 8

### ATRP of DMAEMA from Paper with 100% of ATRP Initiator and its Quaternization by methyl iodide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of methyl iodide in 15 ml of nitromethane was used for quaternization. The polymerization and quaternization were conducted in accordance with Example 2.

### Example 9

### ATRP of DMAEMA from Paper with 100% of ATRP Initiator and its Quaternization by methyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of methyl bromide in 15 ml of nitromethane was used for quaternization. The polymerization and quaternization were conducted in accordance with Example 2.

### Example 10

### ATRP of DMAEMA from Paper with 100% of ATRP Initiator and its Quaternization by methyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of propyl bromide in 15 ml of nitromethane was used for quaternization. The polymerization and quaternization were conducted in accordance with Example 2.

### Example 11

### ATRP of DMAEMA from Paper with 100% of ATRP Initiator and its Quaternization by butyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of butyl bromide in 15 ml of nitromethane was used for quaternization. The polymerization and quaternization were conducted in accordance with Example 2.

### Example 12

### ATRP of DMAEMA from Paper with 100% of ATRP Initiator and its Quaternization by pentyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of pentyl bromide in 15 ml of nitromethane was used for quaternization. The polymerization and quaternization were conducted in accordance with Example 2.

### Example 13

### ATRP of DMAEMA from Paper with 100% of ATRP Initiator and its Quaternization by hexyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of hexyl bromide in 15 ml of nitromethane was used for quaternization. The polymerization and quaternization were conducted in accordance with Example 2.

### Example 14

### ATRP of DMAEMA from Paper with 100% of ATRP Initiator and its Quaternization by heptyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of heptyl bromide in 15 ml of nitromethane was used for quaternization. The polymerization and quaternization were conducted in accordance with Example 2.

### Example 15

### ATRP of DMAEMA from Paper with 100% of ATRP Initiator and its Quaternization by octyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of octyl bromide in 15 ml of nitromethane was used for quaternization. The polymerization and quaternization were conducted in accordance with Example 2.

### Example 16

### ATRP of DMAEMA from Paper with 100% of ATRP Initiator and its Quaternization by nonyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of nonyl bromide in 15 ml of nitromethane was used for quaternization. The polymerization and quaternization were conducted in accordance with Example 2.

### Example 17

### ATRP of DMAEMA from Paper with 100% of ATRP Initiator and its Quaternization by decyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of decyl bromide in 15 ml of nitromethane was used for quaternization. The polymerization and quaternization were conducted in accordance with Example 2.

### Example 18

### ATRP of DMAEMA from Paper with 100% of ATRP Initiator and its Quaternization by undecyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of undecyl bromide in 15 ml of nitromethane was used for quaternization. The polymerization and quaternization were conducted in accordance with Example 2.

### Example 19

### ATRP of DMAEMA from Paper with 100% of ATRP Initiator and its Quaternization by dodecyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of dodecyl bromide in 15 ml of nitromethane was used for quaternization. The polymerization and quaternization were conducted in accordance with Example 2.

### Example 20

### ATRP of DMAEMA from Paper with 100% of ATRP Initiator and its Quaternization by tridecyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of tridecyl bromide in 15 ml of nitromethane was used for quaternization. The polymerization and quaternization were conducted in accordance with Example 2.

### Example 21

### ATRP of DMAEMA from Paper with 100% of ATRP Initiator and its Quaternization by tetradecyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of tetradecyl bromide in 15 ml of nitromethane was used for quaternization. The polymerization and quaternization were conducted in accordance with Example 2.

### Example 22

### ATRP of DMAEMA from Paper with 100% of ATRP Initiator and its Quaternization by heptadecyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of heptadecyl bromide in 15 ml of nitromethane was used for quaternization. The polymerization and quaternization were conducted in accordance with Example 2.

### Example 23

### ATRP of DMAEMA from Paper with 100% of ATRP Initiator and its Quaternization by hexadecyl bromide

ATRP of DMAEMA on paper was accomplished by immersing the initiator-modified paper prepared in accordance with Example 1 into the reaction mixture containing 5 g of DMAEMA, 0.035 g of CuBr, 0.070 g of bpy, and 5 g of 1,2-dichlorobenzene. 5 ml of hexadecyl bromide in 15 ml of nitromethane was used for quaternization. The polymerization and quaternization were conducted in accordance with Example 2.

### Example 24

### ATRP of MEMA from Paper with 100% of ATRP Initiator and its Quaternization by methyl bromide

ATRP of MEMA on paper was accomplished by immersing the initiator-modified paper prepared in accordance with Example 1 into the reaction mixture containing 5 g of MEMA, 0.035 g of CuBr, 0.070 g of bpy, and 5 g of 1,2-dichlorobenzene. 5 ml of methyl bromide in 15 ml of nitromethane was used for quaternization. The polymerization and quaternization were conducted in accordance with Example 2.

### Example 25

### ATRP of acrylamide from Paper with 100% of ATRP Initiator and its Quaternization by methyl bromide

ATRP of acrylamide on paper was accomplished by immersing the initiator-modified paper prepared in accordance with Example 1 into the reaction mixture containing 5 g of acrylamide, 0.035 g of CuCl, 0.070 g of bpy, and 5 g of N,N-dimethylformamide (DMF). 5 ml of methyl bromide in 15 ml of nitromethane was used for quaternization. The polymerization and quaternization were conducted in accordance with Example 2.

### Example 26

### ATRP of acrylonitrile from Paper with 100% of ATRP Initiator and its Quaternization by methyl bromide

ATRP of acrylonitrile on paper was accomplished by immersing the initiator-modified paper prepared in accordance with Example 1 into the reaction mixture containing 5 g of acrylonitrile, 0.035 g of CuBr, 0.070 g of bpy, and 5 g of ethylene carbonate. 5 ml of methyl bromide in 15 ml of nitromethane was used for quaternization. The polymerization and quaternization were conducted in accordance with Example 2.

### Example 27

### ATRP of vinyl acetate from Paper with 100% of ATRP Initiator and its Quaternization by methyl bromide

ATRP of vinyl acetate on paper was accomplished by immersing the initiator-modified paper prepared in accordance with Example 1 into the reaction mixture containing 5 g of vinyl acetate, 0.035 g of CuBr, and 0.070 g of bpy. 5 ml of ethyl bromide in 15 ml of nitromethane was used for quaternization. The polymerization and quaternization were conducted in accordance with Example 2.

### Example 28

### ATRP of 2-hydroxyethyl methacrylate (HEMA) and DMAEMA from Paper with 100% of ATRP Initiator and its Quaternization by methyl bromide

ATRP of 2-hydroxyethyl methacrylate on paper was accomplished by immersing the initiator-modified paper prepared in accordance with Example 1 into the reaction mixture containing 5 g of HEMA, 0.035 g of CuBr, 0.070 g of bpy, and 5 g of 1,2-dichlorobenzene. Immobilization of ATRP initiator on HEMA-modified paper was prepared by reacting 5 ml of 2-bromoisobutyryl bromide with the pendant hydroxyl groups of the HEMA-modified paper (25 mm×25 mm) for 24 h at room temperature. Resultant filter paper was thereafter thoroughly washed with dichloromethane/acetone/water.

Further ATRP of DMAEMA on HEMA-modified paper was accomplished by immersing the HEMA-modified paper into the reaction mixture containing 5 g of DMAEMA, 0.035 g of CuBr, 0.070 g of bpy, and 1,2-dichlorobenzene. 5 ml of methyl bromide in 15 ml of nitromethane was used for quaternization. The quaternization were conducted in accordance with Example 2.

### Example 29

### ATRP of p-chloromethyl stryrene from Paper with 100% of ATRP Initiator and its Quaternization by methyl bromide

ATRP of p-chloromethyl stryrene on paper was accomplished by immersing the initiator-modified paper prepared in accordance with Example 1 into the reaction mixture containing 5 g of p-chloromethyl stryrene, 0.035 g of CuBr, 0.070 g of bpy, and 5 g of toluene. 5 ml of methyl bromide in 15 ml of nitromethane was used for quaternization. The polymerization and quaternization were conducted in accordance with Example 2.

### Example 30

### ATRP of 2-vinyl pyridine (2-VP) from Paper with 100% of ATRP Initiator and its Quaternization by methyl bromide

ATRP of 2-VP on paper was accomplished by immersing the initiator-modified paper prepared in accordance with Example 1 into the reaction mixture containing 5 g of 2-VP, 0.035 g of CuCl, 0.070 g of tris[2-(dimethylamino)ethyl]amine (Me₆-TREN), and 5 g of 2-propanol. 5 ml of methyl bromide in 15 ml of nitromethane was used for quaternization. The polymerization and quaternization were conducted in accordance with Example 2.

### Example 31

### ATRP of 4-VP from Paper with 100% of ATRP Initiator and its Quaternization by methyl bromide

ATRP of 4-VP on paper was accomplished by immersing the initiator-modified paper prepared in accordance with Example 1 into the reaction mixture containing 5 g of 4-VP, 0.035 g of CuCl, 0.070 g of tris[2-(dimethylamino)ethyl]amine (Me₆-TREN), and 5 g of 2-propanol. 5 ml of methyl bromide in 15 ml of nitromethane was used for quaternization. The polymerization and quaternization were conducted in accordance with Example 2.

### Example 32

### ATRP on Glass Surfaces

Any of the reactions described in examples 1-31 except that the substrate surface is glass and not paper.

Embodiments of the method result in permanent non-leaching antibacterial surfaces without the need to chemically graft the antimicrobial material to the substrate. In one embodiment, a tertiary amine, 2-dimethylamino)ethyl methacrylate, was polymerized directly onto Whatman #1 filter paper or glass slides. Following the polymerization, the tertiary amino groups were quaternized using an alkyl halide to produce a large concentration of quaternary ammonium groups on the polymer-modified surfaces. Incubating the modified materials with either Escherichia coli or Bacillus subtilis demonstrated that the modified surfaces had substantial antimicrobial capacity. The permanence of the antimicrobial activity was demonstrated through repeated use of a modified glass without significant loss of activity.

Quaternary amines are believed to cause cell death by disrupting cell membranes allowing release of the intracellular contents. Atomic force microscopic imaging of cells on modified glass surfaces supports this hypothesis.

### Example 33

### Performance of Various Modified Papers in the ASTM Standard Test Method for Determining the Antimicrobial Activity of Immobilized Antimicrobial Agents Under Dynamic Contact Conditions. ASTM Designation E 2149-01.

Protocol: Bacteria (E. coli) are grown overnight in Luria broth and diluted to ˜3×10⁵ CFU/ml in 30 mM phosphate buffer at pH 7.0. The bacteria are then incubated with the material under vigorous agitation. For these experiments 50 mg of modified paper (as prepared in examples 1-6) was incubated with 5 ml of bacteria in a 50 ml conical tube in a shaking incubator (37° C. and 300 rpm). After 1 hour an aliquot is removed, serially diluted, plated on L agar and incubated overnight at 37° C. Surviving bacteria are counted as colony forming units.

The various samples are papers with a ratio of active ATRP initiator to blocking agent as indicated by the percentage of active initiator in the mixture. Note that the control is pure paper incubated under conditions identical to the test papers.

TABLE 2

| Sample | CFU/ml | Log Kill |
|---|---|---|
| Control | 3.5 × 10⁵ | 0 |
| 1% initiator | 0 | >5.5 |
| 10% initiator | 0 | >5.5 |
| 25% initiator | 0 | >5.5 |
| 50% initiator | 0 | >5.5 |
| 75% initiator | 0 | >5.5 |
| 100% initiator | 0 | >5.5 |

### Example 34

### Table 3. Performance of Various Modified Papers in a Modified Version of the ASTM Standard Test Method for Determining the Antimicrobial Activity of Immobilized Antimicrobial Agents Under Dynamic Contact Conditions. ASTM Designation E 2149-01.

Protocol: Bacteria (E. coli) are grown overnight in Luria broth and diluted to ˜5×10⁷ CFU/ml in 30 mM phosphate buffer at pH 7.0. (note: the ASTM standard is 3×10⁵ CFU/ml). The bacteria are then incubated with the material under vigorous agitation. For these experiments 50 mg of modified paper (as prepared in examples 1-6) was incubated with 5 ml of bacteria in a 50 ml conical tube in a shaking incubator (37° C. and 300 rpm). After 1 hour an aliquot is removed, serially diluted, plated on L agar and incubated overnight at 37° C. Surviving bacteria are counted as colony forming units.

The various samples are papers with a ratio of active ATRP initiator to blocking agent as indicated by the percentage of active initiator in the mixture. Note that the control sample is pure paper incubated under conditions identical to the test papers.

TABLE 3

| Sample | CFU/ml | Log Kill |
|---|---|---|
| Control | 5.2 × 10⁷ | 0 |
| 1% | 0 | >7.7 |
| 10% | 0 | >7.7 |
| 25% | 0 | >7.7 |
| 50% | 0 | >7.7 |
| 75% | 0 | >7.7 |
| 100% | 0 | >7.7 |

### Example 35

### Kill of Bacillus subtilis by modified Papers

Protocol: a) For vegetative B. subtilis, the cells were grown in Luria broth overnight and diluted in sterile water to about 3×10⁶ CFU/ml. 2 ml of cells were mixed with a 2.5×2.5 cm piece of modified paper (100% ATRP initiator) and incubated for 1 hour at 37° C. and 250 rpm. An aliquot was serially diluted, plated on L agar plates, and the plates incubated overnight at 37° C. Surviving cells were counted as colony forming units. b) For spores; B. subtilis cells were grown 48 hours in minimal medium, collected by centrifugation resuspended in distilled water, heated to 80° C. for 20 minutes, collected by centrifugation, heated to 85° C. for 20 min, collected by centrifugation, and resuspended in distilled water. Immediately prior to use the suspension was heated to 100° C. for 3 minutes. The boiled spore suspension was then incubated with pure paper or modified paper as described for the vegetative cells.

TABLE 4

| Sample | CFU/ml | Log Kill |
|---|---|---|
| B. subtilis vegetative cells on | 3.1 × 10⁶ | 0 |
| pure paper | | |
| B. subtilis vegetative cells on | 3.0 × 10² | 4 |
| modified paper | | |
| B. subtilis spores on pure paper | 1.25 × 10⁶ | 0 |
| B. subtilis spores on modified | 6.6 × 10⁵ | 0.29 |
| paper | | |

### Example 36

### Time Course of E. coli Kill on Modified Glass Surfaces

Protocol: Bacteria (E. coli) are grown overnight in Luria broth and diluted to ˜1×10⁶ CFU/ml in 30 mM phosphate buffer at pH 7.0. Five ml of the bacterial solution are then incubated with the a 2.0×2.5 cm piece of glass (modified as described in Example 32) in a 50 ml conical tube in a shaking incubator (37° C. and 300 rpm). At various time points an aliquot is removed, serially diluted, plated on L agar and incubated overnight at 37° C. Surviving bacteria are counted as colony forming units.

TABLE 5
Time course of E. coli kill on modified glass surfaces.

| Sample | CFU/ml | Log Kill |
|---|---|---|
| Control (Time 0) | 1.6 × 10⁶ | 0 |
| 5 minutes | 8.1 × 10³ | 2.3 |
| 15 minutes | 0 | >6.2 |

### Example 37

### Kill of Vegetative B. subtilis on Modified Glass

Protocol: Vegetative B. subtilis cells were grown in Luria broth overnight and diluted in sterile water to about 3×10⁶ CFU/ml. 2 ml of cells were mixed with a 2.0×2.5 cm piece of modified glass (100% ATRP initiator) and incubated for 1 hour at 37° C. and 250 rpm. An aliquot was serially diluted, plated on I agar plates, and the plates incubated overnight at 37° C. Surviving cells were counted as colony forming units. The control was a 2.0×2.5 cm piece of plain unmodified glass

TABLE 6

| Sample | CFU/ml | Log Kill |
|---|---|---|
| Control (plain glass) | 2 × 10⁴ | 0 |
| Test (Modified glass) | 0 | >4.3 |

### Example 38

### Reusability of Modified Glass Slides

Glass slides were used to test the reusability of the modified surfaces because the paper began to fragment after a single use.

Protocol: Bacteria (E. coli) are grown overnight in Luria broth and diluted to ˜5×10⁵ CFU/ml in 30 mM phosphate buffer at pH 7.0. Two ml of the bacterial solution are then incubated with the a 2.0×2.5 cm piece of glass (modified as described in Example 32) in a 17×100 mm polystyrene test tube in a shaking incubator (37° C. and 300 rpm). After 1 hour an aliquot is removed, serially diluted, plated on L agar, and incubated overnight at 37° C. Surviving bacteria are counted as colony forming units.

Glass slides were prepared and incubated with approximately 1×10⁶ CFU of E. coli. Following incubation the glasses were washed as indicated dried and retested. The intervals between test rounds varied with the entire series completed over the course of 4 weeks. The results of these experiments are shown in Table 7.

Following the incubation the bacterial solution is removed and the glass is rinsed twice with 2 ml of phosphate buffer and allowed to dry. Prior to the next round of cell kill one piece of modified glass is vigorously agitated (10 sec on a vortex mixer) with 2 ml of a 0.1% solution of the detergent sodium dodecyl-sulfate (SDS). The glass is rinsed twice to remove the detergent and tested. A second glass is treated identically except that the SDS is not included. An identically sized piece of plain glass acts as the control in all cases. The plain glass is treated with the SDS to control for any effect that treatment may cause. At the end of the third round of testing the modified glass washed in buffer only (Table 7, modified glass #1) was no longer able to kill bacteria. For the next round of testing this sample was also washed with SDS as described above.

As shown in Table 7 the ability to kill bacteria is restored by this treatment

TABLE 7
Reusability of Modified Glass

| Sample | Round 1 | Round 2 | Round 3 | Round 4 | Round 5 |
|---|---|---|---|---|---|
| ¹Plain Glass | 1.1 × 10⁶ | 1.0 × 10⁶ | 1.3 × 10⁶ | 1.3 × 10⁶ | 1.5 × 10⁶ |
| ²Modified | <10 | 120 | 1.2 × 10⁶ | 50 | <10 |
| Glass#1 | | | | | |
| ¹Modified | <10 | <10 | <10 | 780 | <10 |
| Glass #2 | | | | | |

¹Washed with 0.1% SDS;
²Washed with buffer after rounds 1 and 2 and with 0.1% SDS after rounds 3-5.

Embodiments comprising polymers having quaternary ammonium salts and low molecular weight distributors attached to glass have been shown to be biocidally active and durable. Experiments show that the surface treatment is resistant to detergents, is durable, and can be regenerated by a simple washing. It should be noted that without a detergent in the wash there was an apparent accumulation of material that blocked the antimicrobial activity (Table 3 Modified glass #1). This material was removed by a subsequent detergent wash and the surface was once again antimicrobial. This result agrees with the notion that the mechanism of action of quaternary amines involves disruption of the plasma membrane causing the release of intracellular material. A material deposit on the surface of the glass was also seen using the Atomic Force Microscope (AFM).

### Example 39

Cleaved polymers from filter papers were analyzed by gel permeation chromatography at 30° C. in 0.1% tetrabutylammonium bromide solution in DMF using Water 717 column calibrated against PMMA standards. AFM measurements were obtained on polymers on flat glass, using a Digital Instruments (Santa Barbara, Calif.) Nanoscope III in tapping mode with a 2 Hz scan rate. Polymers were grown via surface initiated polymerization on filter paper and removed by acid hydrolysis in a 1 mM HCl aqueous solution overnight. HCl aqueous solution was removed by evaporation, and the remaining polymer was dissolved in 100 μL of DMF and analyzed by GPC. See Table 1.

Antimicrobial Susceptibility Determination. Antimicrobial testing was performed using a modified ASTM standard: E 2149-01 “Standard Test Method for Determining the Antimicrobial Activity of Immobilized Antimicrobial Agents Under Dynamic Contact Conditions”. Stock Escherichia coli K12 (E. coli) were used to inoculate 5 mL of sterile growth media in a sterile 50 mL conical tube. The culture was incubated at 37° C. while being shaken at 300 RPM (G24 Environmental Incubator Shaker, New Brunswick Scientific) for 18-20 hr. Assuming 5×10⁹ cells per mL after incubation, the cells were diluted with Sorenson's Phosphate Buffer (pH 6.8, 0.3 mM KH₂PO₄) to any desired concentration. The exact concentration of cells in the diluted solution, called “0” contact time, was determined by standard serial dilution. One 15×25 mm glass slide was placed in a sterile 50 mL conical tube and 5 mL of diluted cell solution was added. A control of unmodified glass slide (15×25 mm) was prepared in the same manner. Both tubes were incubated at 37° C. with shaking at 300 RPM. After 1 hr, 1±0.01 mL from each tube was transferred to a test tube, and serial dilutions were performed. The dilutions were plated on L. agar, and the petri dishes from both examples incubated at 37° C. for 20-24 hr. Colonies were counted and converted to colony forming units per milliliter (CFU/mL) of buffer solution in the original dilution.

Antimicrobial activity. The ability of the modified surfaces to kill bacteria was tested for both the paper and glass preparations. For the paper experiments 2.5×2.5 cm pieces of modified paper were shaken with 5 mL of a bacterial suspension for 1 hour at 37° C. The number of viable cells in the suspension was determined before and after incubation by dilution of the samples followed by overnight incubation on agar plates. Glass samples were 1.25×2.5 cm and were incubated with 2 mL of bacterial suspension. Incubating a non-modified sample of glass or paper and determining the number of viable cells was used as a control to determine the initial number of cells. Table 8 gives the results of several of these experiments. The results show that the paper was extremely effective against E. coli killing>10⁹ cells. The activity against B. subtilis vegetative cells was more modest killing 6×10⁶ cells and 1.2×10⁶ B. subtilis spores. The glass slides were also effective at killing bacteria killing 9×10⁶ E. coli and >4×10⁴ B. subtilis vegetative cells.

TABLE 8
Antimicrobial activity of modified paper and glass

| Sample | Organism | CFU¹ Initial | CFU Final |
|---|---|---|---|
| Paper | E. coli | 2.6 × 10⁸ | 0 |
| Paper | E. coli | 1.6 × 10⁹ | 4.9 × 10⁵ |
| Paper | B. subtilis | 6.2 × 10⁶ | 6.0 × 10² |
| Paper | B. subtilis Spores | 2.5 × 10⁶ | 1.3 × 10⁶ |
| Glass | E. coli | 9.4 × 10⁶ | 1.4 × 10⁴ |
| Glass | B. subtilis | 1.0 × 10⁴ | 0 |

¹Colony Forming Units

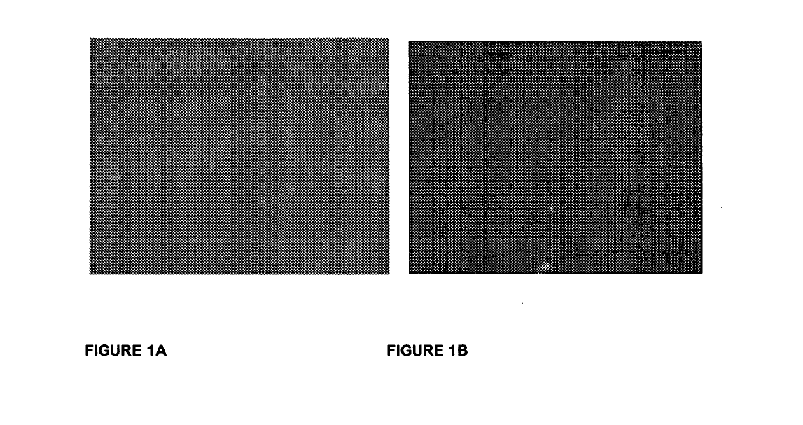

In order to confirm that the bacteria were indeed killed and not just bound to the surface, we used the LIVE/DEAD BacLight kit from Molecular Probes to differentiate living verses killed bacteria. E. coli cells were incubated with modified and non-modified papers as described above except that samples were taken at various times and the cells were stained and viewed with a fluorescence microscope. FIG. 1 shows the results of this experiment after 15 minutes incubation. Using this technique live cells are stained green and dead cells are stained red. FIGS. 1A and 1B show that after 15 minutes the majority of cells are dead when incubated with the modified paper but are still alive with the non-modified paper.

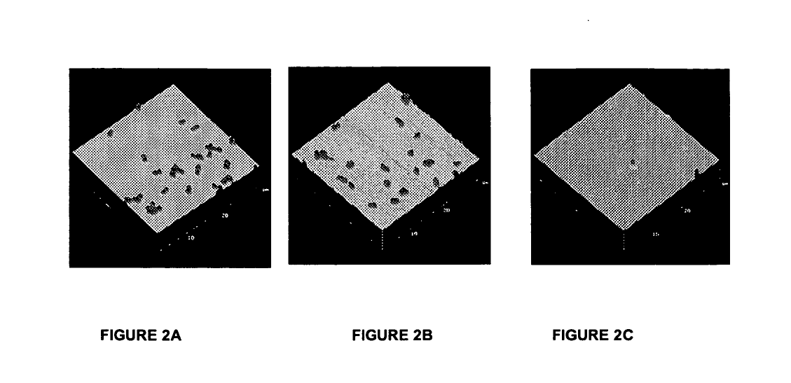

AFM was used to gain some insight into the biocidal mechanism of the quaternized surfaces (FIG. 2). E. coli was imaged on unmodified glass (FIG. 2A), and quaternized glass (FIG. 2B). These images were then compared to a sample of quaternized glass that had not been exposed to any bacteria (FIG. 2C). Inspection of FIG. 2B shows some sort of material is present on the surface of the quaternized glass that is affecting the interaction microscope tip and the surface. The altered interaction shows up on the image as a different color as compared to FIGS. 2A and 2C. Since the material is not present on sterile quaternized glass or on plain glass slides coated with bacteria, we believe that the material in FIG. 2B is either intracellular contents or outer membrane fragments.

A number of natural polycationic compounds like the antibiotic polymyxin and several small antimicrobial peptides are thought to work by displacing the divalent cations that are thought crucial to the organization of the lipopolysaccharide of bacterial cell walls. This is believed to hold true for the compounds described herein. Additionally, these amphiphiylic polycations are thought to penetrate the plasma membrane causing leakage of the intracellular contents. The action of polycationic compounds in Gram-positive bacteria, which have a thick cell wall, is thought to be similar in that the polycation first penetrates the outer cell-wall and finally reaches and disrupts the plasma membrane causing leakage. The polymers synthesized in this study are believed to exhibit this type of membrane-penetrating mechanism and the debris seen on the quaternized glass slides (FIG. 2B) are thought to be intracellular components that leaked out of the cell during its death.

Embodiments of the present invention provide a method for producing an antimicrobial polymer using ATRP which can be synthesized on a number of common materials including glass and paper. Using ATRP to perform a living radical polymerization of DMAEMA gives polymer chains of controlled molecular weights, low polydispersities, and definable structure. Subsequent quaternization of the amino group provides the biocidal functionality using the polymer chain as a delivery mechanism. When the substratum was paper, a 6.25 cm² piece was sufficient to kill 10⁹ bacteria. The possible uses of a permanent, non-leaching biocidal surface treatment such as the one described herein would include treatment of food packaging, everyday household items, as well as military applications, such as anti-biowarfare equipment, clothing, masks, glasses, helmets, air filters and respirators; laboratory equipment, such as glassware, plasticware, countertops, parts of equipment, beads for use in columns, especially multi-use chromatography apparatuses, to prevent fouling; medical equipments, such as, catheters, balloons, surgical instruments, laparoscopic or arthroscopic instruments, contact lenses, sutures, wound dressings, bandages, compresses, absorbents, and parts for both passive and active transdermal drug delivery devises, such as iontophoretic patches including non-wovens, packaging materials and reservoirs, countertops, bedding, wipes, and towels; food service equipment, such as, countertops, appliance surfaces, tableware, food storage containers, commercial food packaging, such as bags, wrappers, liners, wipes and towels, and glassware; household items, such as, countertops, appliance surfaces, tableware, food storage containers, sinks, tubs, toilets, urinals, bidets, bath enclosures, wallpaper, paints, grout, caulk, tiles, contact paper, wipes and towels, plastic pools, pool liners, toys, pipes, wood, flooring (especially bathroom and locker room floor), trash receptacles, and glass; personal care items, such as, toothbrushes, razors, dippers, scissors, grooming devices, clothing, and shoe liners; industrial applications, such as, components of cooling towers, filters, clean room filtration equipment, air conditioning units, and food processing equipment, such as, chicken and seafood processing equipment; and other items, such as, boat hulls, aquarium surfaces, papers, fibers, fabrics, glass, ceramics, metals, plastics.

1. A biocidal article, comprising:
a plurality of polymers having biocidally active groups, wherein the polymers are attached to a surface and have a polydispersity less than 3.

2. The biocidal article of claim 1, wherein the polydispersity is less than 2.5.

3. The biocidal article of claim 2, wherein the polydispersity is less than 2.0.

4. The biocidal article of claim 1, wherein at least a portion of the polymers comprise a hydrophobic backbone and pendant hydrophilic functional groups.

5. The biocidal article of claim 1, wherein the biocidally active groups comprise at least one of a quaternary ammonium salt and a quaternary phosphonium salt.

6. The biocidal article of claim 1, wherein the biocidally active groups comprise cell membrane disruptive functionality.

7. The biocidal article of claim 1, wherein the biocidally active group comprises a chloroamine.

8. The biocidal article of claim 1, wherein the plurality of copolymers are one of homopolymers and copolymers.

9. The biocidal article of claim 1, wherein the plurality of polymers comprise at least one of a block copolymer, multiblock copolymer, a random copolymer, graft polymer, a branched or a hyperbranched polymer, and a gradient copolymer.

10. The biocidal article of claim 9, wherein at least a portion of the plurality of polymers are copolymers.

11. The biocidal article of claim 10, wherein at least a portion of the plurality of polymers comprise three or more different monomer units.

12. The biocidal article of claim 1, wherein the plurality of polymers have an average degree of polymerization between 4 and 5000.

13. The biocidal article of claim 12, wherein the plurality of polymers have an average degree of polymerization between 4 and 1000.

14. The biocidal article of claim 13, wherein the plurality of polymers have an average degree of polymerization between 100 and 1000.

15. The biocidal article of claim 1, wherein monomers comprise the biocidal active groups.

16. The biocidal article of claim 15, wherein monomers comprising the biocidal active groups are less than 75% of all the monomers in the plurality of polymers.

17. The biocidal article of claim 16, wherein monomers comprising the biocidal active groups are less than 50% of all the monomers in the plurality of polymers.

18. The biocidal article of claim 17, wherein monomers comprising the biocidal active groups are less than 25% of all the monomers in the plurality of polymers.

19. The biocidal article of claim 15, wherein monomers comprising the biocidal active groups are less than 5% of all the monomers in the plurality of polymers.

20. The biocidal article of claim 1, wherein the plurality of polymers comprise at least one monomer selected from hydrophilic monomers and hydrophobic monomers.

21. The biocidal article of claim 15, wherein the monomers comprising the biocidally active groups are derived from at least one of 2-dimethylamino)ethyl methacrylate), 4-vinyl pyridine, 2-vinyl pyridine, N-substituted acrylamides, N-acryloyl pyrrolidine, N-acryloyl piperidine, acryl-L-amino acid amides, acrylonitriles, methacrylonitriles vinyl acetates, 2-hydroxy ethyl methacrylate, p-chloromethyl styrene, and derivatives and substituted varieties of such monomers.

22. The biocidal article of claim 1, wherein the biocidally active group is a cationic antimicrobial.

23. The biocidal article of claim 1, wherein the surface is at least one of silicon, gold, silica functionality, a cellulosic materials, a surfaces with one of amino and hydroxy functionality, plain glass, amino glass, polymeric material, a polymeric coating, polyethylene, polypropylene, polystyrene, aluminum, steel, paper, wood, porcelain, wool, cotton, porous glass beads and ion exchanger resin.

24. The biocidal article of claim 23, further comprising a linking group between the surface and the polymer.

25. The biocidal article of claim 24, wherein the linking group is of the formula: 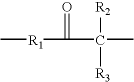
where R₁ is one of O, an ester, amide, aliphatic hydrocarbon, aromatic hydrocarbon or NH, R₂ and R₃ are, independently, one of H, CH₃, OOCC₂H₅ or CN.

26. The biocidal article of claim 1, wherein a monomeric unit of at least a portion of the plurality of polymers comprises the biocidally active group.

27. The biocidal article of claim 26, wherein the monomeric unit is at least one monomeric unit selected from the following formulae: 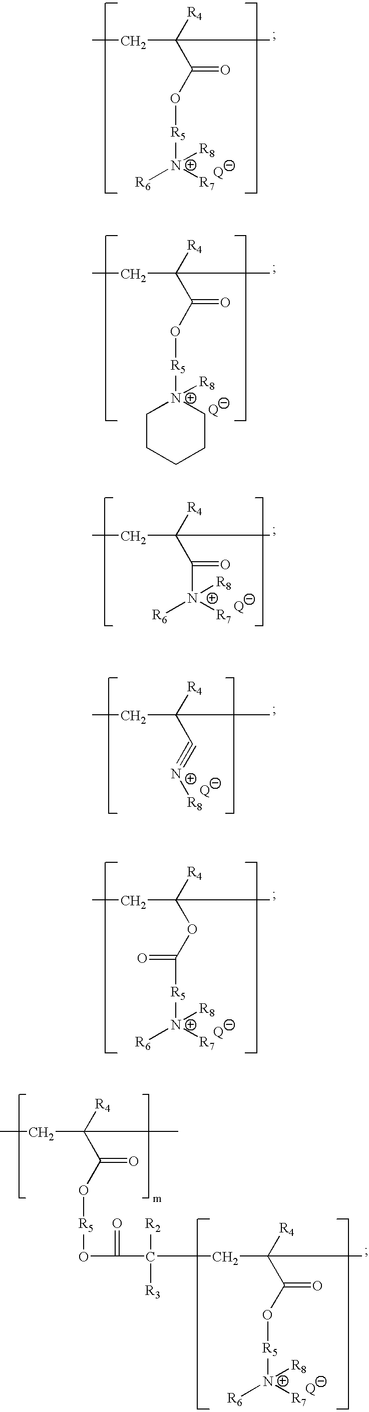 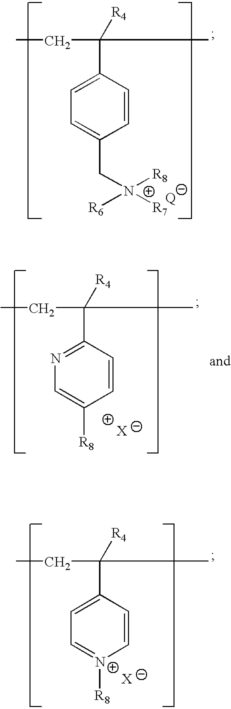
where R₄ is one of H, CH₃, Cl or CN, R₅ is —(CH₂)ₙ— and —CH₂C(CH₃)₂CH₂—, n is from 1 to 6, R₆ and R₇ are, independently, one of alkyl C₁-C₅ or isopropyl, R₈ is H, alkyl C₁-C₁₆ and benzyl and Q is one of F, Cl, Br, I, CF₃SO₃ and CF₃CO₂, individually or in any combination each, X is a radically transferable atom or group or a group derived from the radically transferable atom or group, such as an additional polymer block, a hydroxy group, H, branched or straight chain alkyl or cyclic, and Q is one of F, Cl, Br, I, CF₃SO₃ and CF₃CO₂.

28. A process for the preparation of a biocidal article, comprising:
polymerizing radically polymerizable monomers from an initiator attached to a surface, wherein at least a portion of the monomers comprise at least one group capable of being converted to a biocidally active group; and
converting the group to the biocidally active group, wherein the biocidally active group comprises a quaternary salt.

29. The process of claim 28, wherein the polymerizing is by a controlled polymerization process.

30. The process of claim 29, wherein the controlled polymerization process is one of atom transfer radical polymerization and stable free radical polymerization.

31. The process of claim 28, wherein the polymerizing is in the presence of a system initially comprising a transition metal complex and initiator attached to the surface comprises a radically transferable atom or group.

32. The process of claim 31, wherein the radically transferable atom or group is one of a chlorine, iodine, and bromine.

33. The process of claim 28, wherein the monomers comprise at least one group capable of being converted to a biocidal group are selected from 2-dimethylamino)ethyl methacrylate), 4-vinyl pyridine, 2-vinyl pyridine, N-substituted acrylamides, N-acryloyl pyrrolidine, N-acryloyl piperidine, acryl-L-amino acid amides, acrylonitriles, methacrylonitriles vinyl acetates, 2-hydroxy ethyl methacrylate, p-chloromethyl styrene, and derivatives and substituted varieties of such monomers.

34. The process of claim 28, wherein the converting the group to a quaternary salt comprises reacting the group with an alkyl halide.

35. The process of claim 34, wherein the alkyl halide is one of C₁-C₁₂ alkyl halide.

36. The process of claim 35, wherein the halide of the alkyl halide is one of chlorine and bromine.

37. The process of claim 28, further comprising reacting an compound comprising an initiation group with a functional group on the surface of the article to form the initiator attached to the surface.

38. The process of claim 37, wherein the functional group on the surface is at least one of —OH and —NH₂.

39. The process of claim 37, further comprising reacting a blocking agent without initiation functionality on the functional group on the surface of the article.

40. The process of claim 39, wherein the ratio of blocking agent without initiation functionality to compound with initiation functionality is greater than 1:3.

41. The process of claim 40, wherein the ratio of blocking agent without initiation functionality to compound with initiation functionality is greater than :1:1.

42. The process of claim 41, wherein the ratio of blocking agent without initiation functionality to compound with initiation functionality is greater than 10:1.

43. The process of claim 41, wherein the ratio of blocking agent without initiation functionality to compound with initiation functionality is greater than 100:1.

44. A process for preparing a biocidally active surface, comprising:
reacting monomers with a surface by a controlled radical polymerization to form a polymer attached to the surface, wherein at least a portion of the monomers comprise a biocidally active group.
